(19) United States
(12) Patent Application Publication
(10) Pub. No.: US 2013/0262693 A1
(43) Pub. Date: Oct. 3, 2013

(54) METHODS AND APPARATUS FOR SEGMENTING, DISTRIBUTING, AND RESEGMENTING ADAPTIVE RATE CONTENT STREAMS

(71) Applicants: Chris Phillips, HARTWELL, GA (US); Bob FORSMAN, SUGAR HILL, GA (US); Charles DASHER, Lawrenceville, GA (US); JENNIFER REYNOLDS, Duluth, GA (US)

(72) Inventors: Chris Phillips, HARTWELL, GA (US); Bob FORSMAN, SUGAR HILL, GA (US); Charles DASHER, Lawrenceville, GA (US); JENNIFER REYNOLDS, Duluth, GA (US)

(21) Appl. No.: 13/437,111

(22) Filed: Apr. 2, 2012

(51) Int. Cl. G06F 15/16; H04L 29/06

(52) U.S. Cl. 709/231

(57) ABSTRACT

Methods by a content distribution system and related adaptive streaming segmenter nodes and adaptive streaming re-segmenter nodes are disclosed. An adaptive streaming re-segmenter node includes at least one network interface that receive a series of segmented files for each of a first plurality of content streams having different coding bit rates of a same source media content. Circuitry combines the series of segmented files to generate a second plurality of content streams having different coding bit rates. The circuitry selects among a plurality of distribution container formats responsive to a streaming protocol used by one of the user equipment nodes, and selects among the second plurality of content streams responsive to available resources at the user equipment node. The circuitry also communicates the selected one of the second plurality of content streams toward the user equipment node using the selected distribution container format.

### TECHNICAL FIELD

The present disclosure relates to communication networks and, more particularly, to content distribution systems that provide adaptive rate content streams to user equipment nodes.

### BACKGROUND

Content providers have long struggled with how to provide content at a high availability and high performance to their customers in view of bandwidth limitations in content distribution networks. A Content Delivery Network (CDN) can be a large distributed system of servers deployed in multiple data centers connected to the Internet or other public/private communication network. The goal of a CDN is to serve media content (e.g., video/audio/etc.) to User Equipment nodes (UEs) with high availability and high performance. Example UEs that can receive media content are set-top-boxes, television, multimedia computers, and wireless terminals (e.g., smart phones and tablet computers).

Requests from UEs for media content are typically algorithmically directed to CDN servers that are optimal in some way. When optimizing for performance, CDN server locations that can provide the best performance for serving media content to a UE may be chosen. This may be measured by choosing CDN server locations that have the fewest network node hops, the fastest network bandwidth, or the highest performance availability. Performance can be increased by replicating/moving media content from a central CDN server to distributed Edge replication servers that are located at the edge of the network close to UEs.

The bandwidth requirements for distributing content from content providers to central CDN servers and/or to distributed Edge replication servers have grown tremendously with the proliferation of adaptive streaming content delivery solutions. Adaptive streaming technology is being implemented to handle increasing consumer demands for streaming content from Over The Top (OTT) applications on OTT content servers (e.g., broadcast and on-demand movies/TV/etc.) across a content distribution network to UEs having widely differing performance and protocols. Example adaptive streaming technology that continues to be developed includes Apple initiated HTTP Live Streaming (HLS) protocol, Microsoft initiated Smooth Streaming over HTTP protocol, Adobe initiated Dynamic Streaming protocol, and MPEG Dynamic Adaptive Streaming over HTTP (MPEG DASH) protocol.

Adaptive streaming technology converts a source media content stream into a plurality of content streams having different coding bit rates. A group of multiple bit rate content streams may be transcoded to provide a plurality of groups of multiple bit rate content streams having different distribution container formats that can be required by different streaming protocols used by UEs (e.g., HLS protocol, Smooth Streaming protocol, Dynamic Streaming protocol, MPEG DASH protocol, etc.). Accordingly, a single group of multiple bit rate content streams can result in numerous groups of differently formatted multiple bit rate content streams that need to be distributed and stored at a central CDN server and/or distributed to Edge replication servers to enable high availability and high performance delivery to many different types of UEs. Distributing media content in this manner consumes tremendous system resources.

Distributing media content streams through the content distribution system can be further complicated by operation of many content delivery servers that precludes reading of incoming content streams until the content streams have completed being written to corresponding files. With adaptive bit rate files, which can grow in real time for live media content, the delay in forwarding of content from one content delivery server to another content delivery or UE may result in reduced or unacceptable content delivery performance.

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

### SUMMARY

Some embodiments are directed to a method by a content distribution system for providing adaptive rate content streams to a plurality of user equipment nodes. The method includes receiving a first plurality of content streams having different coding bit rates of a same source media content. Each of the first plurality of content streams are segmented into a corresponding series of segmented files. The series of segmented files for each of the first plurality of content streams are communicated from an adaptive streaming segmenter node toward an adaptive streaming re-segmenter node through a content distribution network using a single distribution container format for each of the series of segmented files. At the adaptive streaming re-segmenter node, each of the series of segmented files are combined to generate a second plurality of content streams having different coding bit rates. A plurality of distribution container formats are selected among responsive to a streaming protocol used by one of the user equipment nodes. The second plurality of content streams are selected responsive to available resources at the user equipment node. The selected one of the second plurality of content streams is communicated from the adaptive streaming re-segmenter node toward the user equipment node using the selected distribution container format.

Because the plurality of content streams are segmented into a series of segmented files, each of the segmented files can be quickly made available for reading after writing is completes by a CDN server which requires completion of writing before reading is permitted. Moreover, system resources are conserved by communicating the series of segmented files using a single distribution container format from the adaptive streaming segmenter node to the adaptive streaming re-segmenter node, which is possible because the adaptive streaming re-segmenter node is responsible for de-segmenting and generating a plurality of content streams that are be communication using various different distribution container formats that are compatible with streaming protocols of the UEs.

Some other embodiments are directed to an adaptive streaming segmenter node of a content distribution system that provides adaptive rate content streams for a plurality of user equipment nodes. The adaptive streaming segmenter node includes at least one network interface that is configured to receive a first plurality of content streams having different coding bit rates of a same source media content. The adaptive streaming segmenter node further includes circuitry that is configured to segment each of the first plurality of content streams into a corresponding series of segmented files. The circuit also communicates the series of segmented files for each of the first plurality of content streams toward an adaptive streaming re-segmenter node through the at least one network interface and a content distribution network using a single distribution container format for each of the series of segmented files.

Some other embodiments are directed to an adaptive streaming re-segmenter node of a content distribution system for providing adaptive rate content streams to a plurality of user equipment nodes. The adaptive streaming re-segmenter node includes at least one network interface that is configured to receive a series of segmented files for each of a first plurality of content streams having different coding bit rates of a same source media content. The adaptive streaming re-segmenter node further includes circuitry configured to combine the series of segmented files to generate a second plurality of content streams having different coding bit rates. The circuitry selects among a plurality of distribution container formats responsive to a streaming protocol used by one of the user equipment nodes. The circuitry selects among the second plurality of content streams responsive to available resources at the user equipment node. The circuit also communicates the selected one of the second plurality of content streams toward the user equipment node using the selected distribution container format.

Other methods and apparatuses according to embodiments of the invention will be or become apparent to one with skill in the art upon review of the following drawings and detailed description. It is intended that all such additional methods and apparatuses be included within this description, be within the scope of the present invention, and be protected by the accompanying claims. Moreover, it is intended that all embodiments disclosed herein can be implemented separately or combined in any way and/or combination.

### BRIEF DESCRIPTION OF THE DRAWINGS

The accompanying drawings, which are included to provide a further understanding of the disclosure and are incorporated in and constitute a part of this application, illustrate certain non-limiting embodiment(s) of the invention. In the drawings:

FIG. 1 is a block diagram of a content distribution system that is configured to operate according to some embodiments;

FIG. 2 is a block diagram of a portion of the content distribution system of FIG. 1 according to some embodiments;

FIG. 3 is a data flow diagram that illustrates operations and methods performed by various nodes of the content distribution system of FIGS. 1 and 2 according to some embodiments;

FIG. 4 illustrates a series of segmented content streams that are output by the adaptive streaming segmenter node and received by the adaptive streaming re-segmenter node of FIGS. 1 and 2 according to some embodiments;

FIG. 5 illustrates a plurality of different format content streams that are generated by the adaptive streaming re-segmenter node combining the segmented content streams of FIG. 4 according to some embodiments;

FIGS. 6a-c illustrates a plurality of different format content streams that are generated by the adaptive streaming re-segmenter node combining the segmented content streams responsive to streaming protocols used by a plurality of user equipment nodes according to some embodiments;

FIGS. 7-9 are flowcharts of operations and methods that may be performed by the adaptive streaming segmenter node of FIGS. 1 and 2 according to some embodiments;

FIGS. 10-14 are flowcharts of operations and methods that may be performed by the adaptive streaming re-segmenter node of FIGS. 1 and 2 according to some embodiments; and

FIG. 15 is a block diagram of an example network node that may be used for one or more of the network nodes of FIGS. 1 and 2 and configured to operate according to some embodiments.

### DETAILED DESCRIPTION

The invention will now be described more fully hereinafter with reference to the accompanying drawings, in which embodiments of the invention are shown. This invention may, however, be embodied in many different forms and should not be construed as limited to the embodiments set forth herein.

Some embodiments are directed to a content distribution system in which a series of adaptive streaming friendly encoded content streams, such as audio-video streams, are segmented into a series of files by a network node located in a backend portion of the system, and then transferred in segmented portions having a single distribution container format through a content distribution network to another network node which combines the files to generate a plurality of adaptive rate content streams that can be transcoded, re-muxed, re-segmented into different formats which are compatible for distribution according to a plurality of different streaming protocols to UEs.

Because the plurality of content streams are segmented into a series of segmented files at the backend of the system, each of the segmented files can be quickly made available for reading and further distribution, after writing is completed by a CDN server that requires completion of writing before reading is permitted. Moreover, content distribution system resources are conserved by communicating the series of segmented files using a single distribution container format.

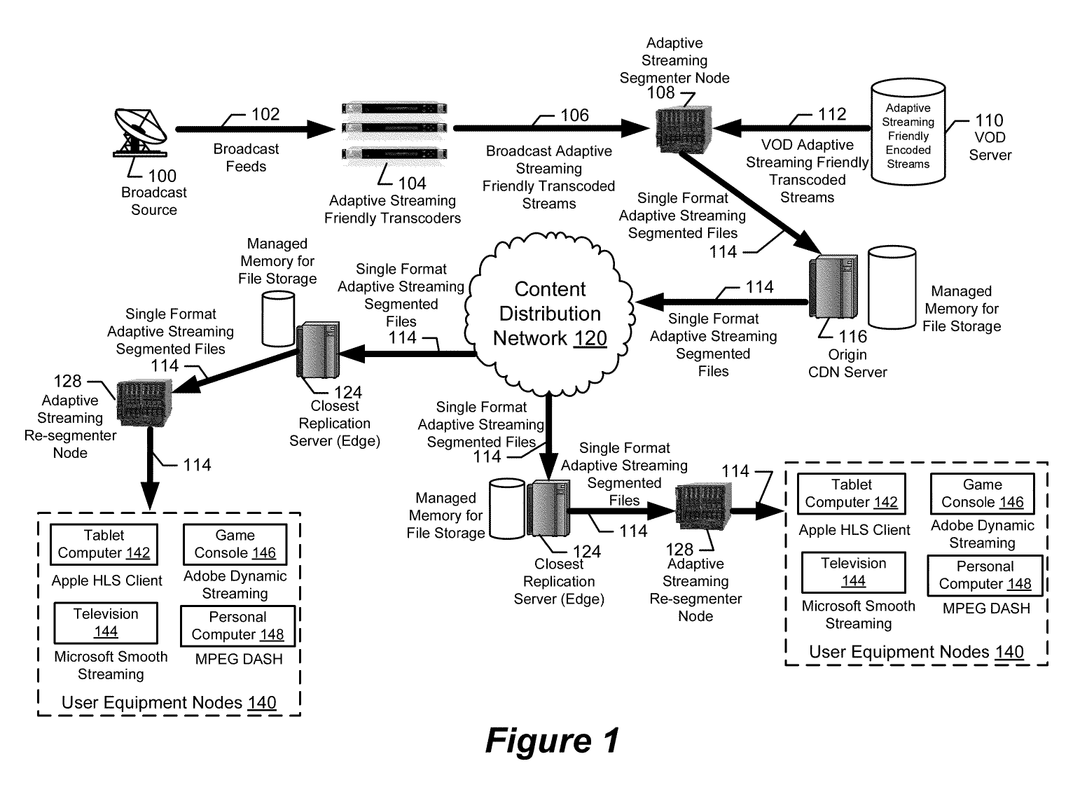

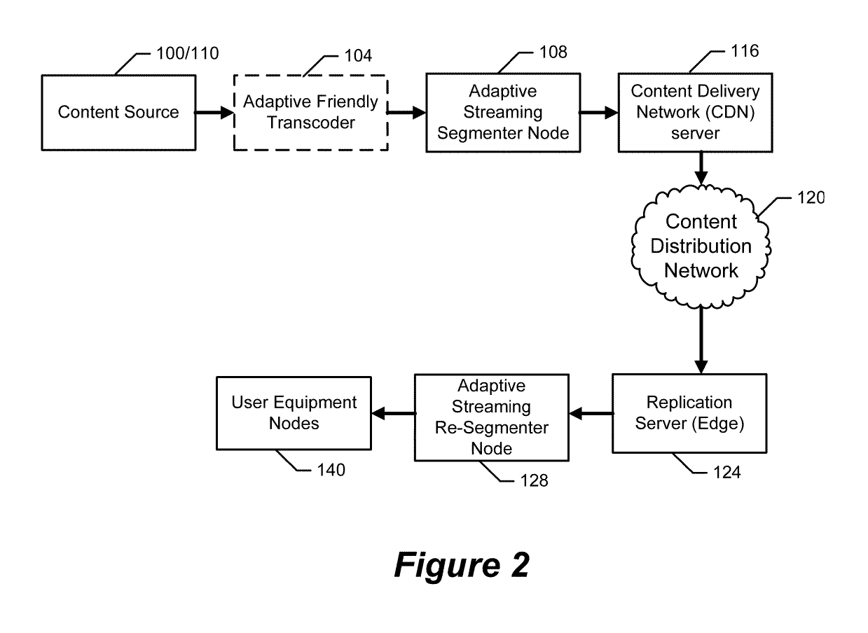

FIG. 1 is a block diagram of a content distribution system that is configured to operate according to some embodiments. FIG. 2 is a simplified block diagram of a portion of the content distribution system of FIG. 1, showing a communication pathway from a content source 110/110 to UEs 140. Referring to FIGS. 1 and 2, the system includes a broadcast source 100 that outputs a broadcast feed 102 (e.g. a content stream containing source media content) to one or more adaptive streaming friendly transcoders 104. The adaptive streaming friendly transcoders 104 output a plurality of content streams 106 (e.g., broadcast adaptive streaming friendly transcoded streams) having different coding bit rates of the same source media content. Thus, for example, a broadcast movie stream 102 can be encoded to provide a plurality of content streams having different coding bit rates (e.g. 4 Mbps, 2 Mbps, 1 Mbps, 500 Kbps, etc.) of the same broadcast movie stream 102 to enable adaptive bit rate streaming capability for a UE.

The content distribution system may alternatively or additionally include a Video on Demand (VOD) server 110 that can stream adaptive streaming friendly encoded content streams 112, which have different coding bit rates of the same source media content. Thus, the content source 100/110 of FIG. 2 may be the broadcast source 100 and/or the VOD server 110. When the content source is the VOD server 110, the adaptive streaming friendly transcoders 104 may not be needed because the adaptive streaming friendly transcoded streams (having different coded bit rates) can already be stored in memory (e.g., magnetic hard drives) of the VOD server 110.

The system also includes a plurality of UEs 140 that, for purposes of explanation of various embodiments, are configured to receive an adaptive content stream using different distribution container formats of different protocols. For example, the UEs 140 may include, but are not limited to, a tablet computer 142 which has a client application that receives an adaptive content stream using a first distribution container format for Apple initiated HLS streaming protocol, a television 144 that receives an adaptive content stream using a second distribution container format for Microsoft initiated Smooth Streaming over HTTP protocol, a game console 146 that receives an adaptive content stream using a third distribution container format for the Adobe initiated Dynamic Streaming protocol, and a personal computer 148 that receives an adaptive content stream using a fourth distribution container format for MPEG DASH protocol.

Consequently, in order to provide adaptive bit rate content streams to the different UEs 140, some network node within the system must generate many different distribution container formats (e.g., four different formats for the UEs 140 of FIG. 1) of the adaptive bit rate content streams. However, instead of generating all of the needed formats at the backend of the system and then streaming the numerous differently formatted versions of the adaptive bit rate content streams through the distribution network, the differently formatted versions are instead generated by a network node that is located closer to the UEs 140 and which may be located at an edge of the distribution network.

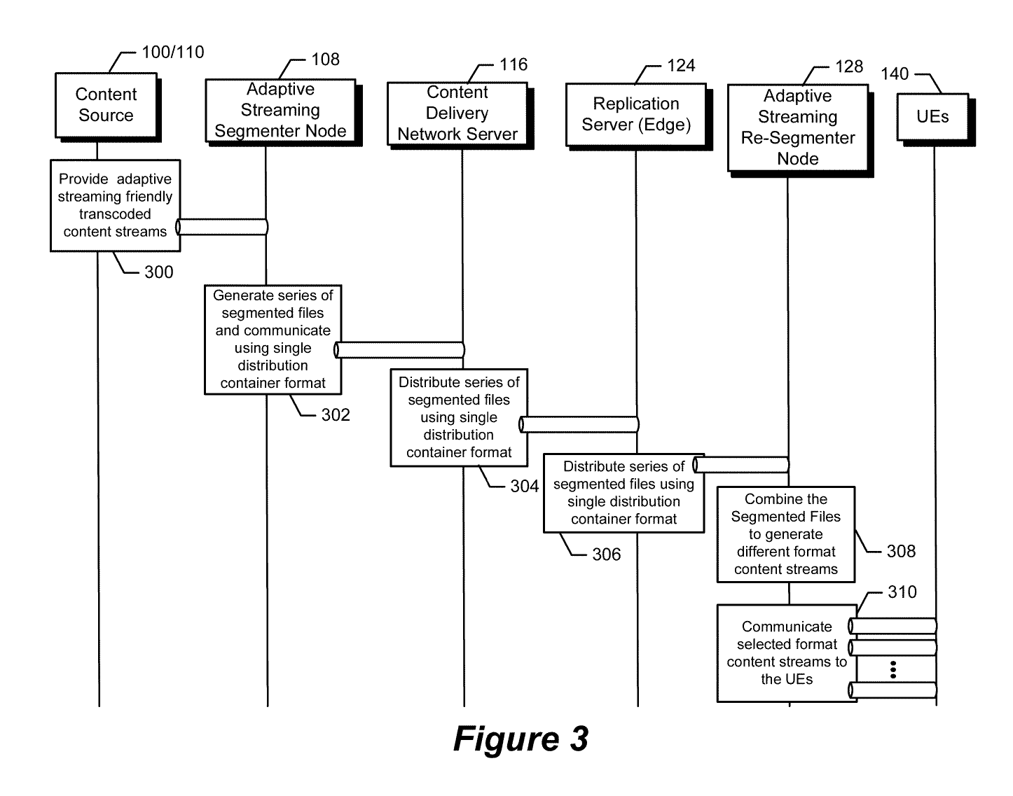

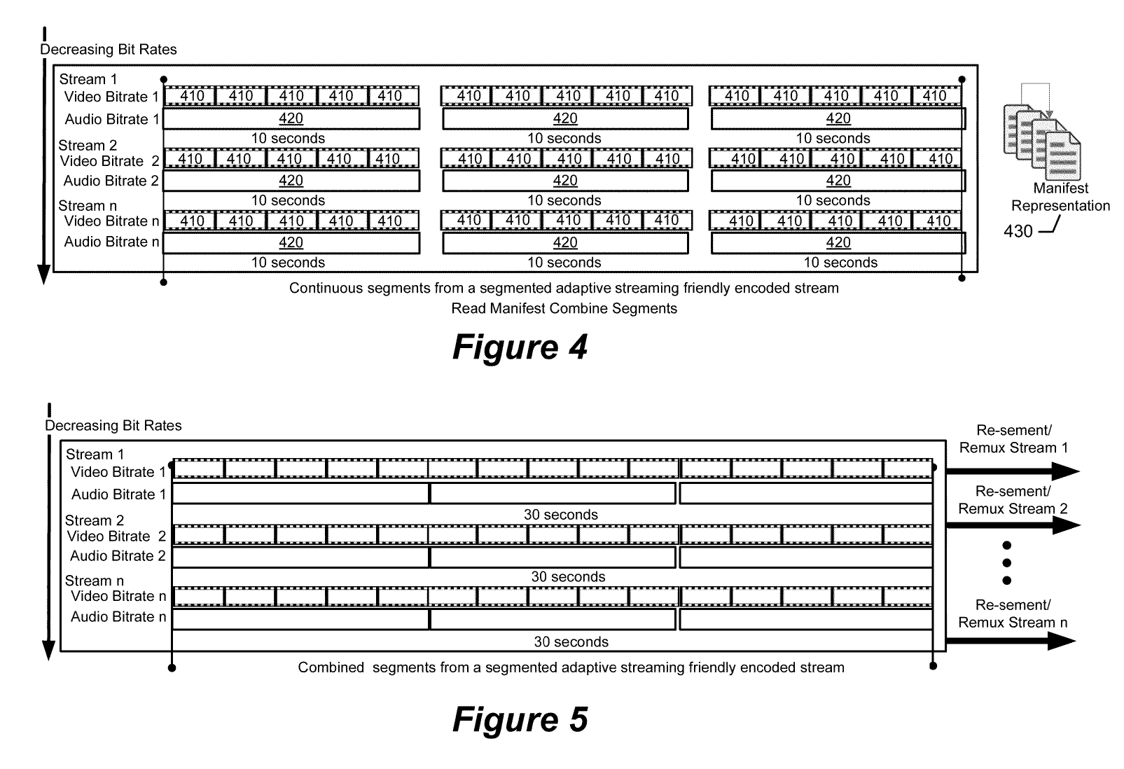

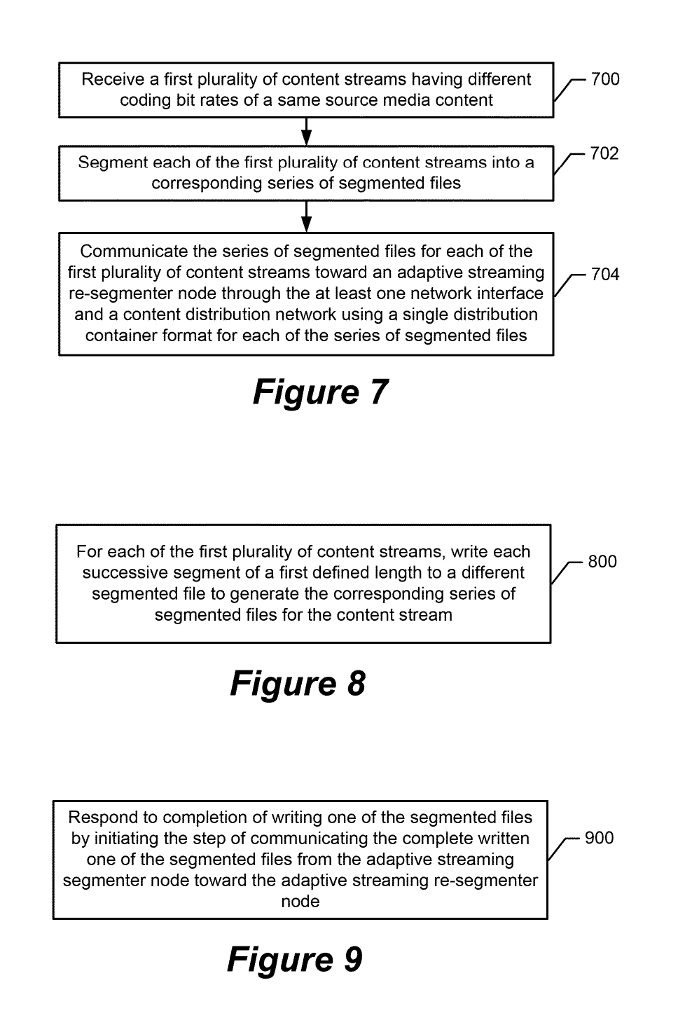

Various operations and methods that may be performed by an adaptive streaming segmenter node 108 and an adaptive streaming re-segmented node 130 to provide differently formatted versions of adaptive bit rate content streams to the UEs 140 are described below with further reference to the data flow diagram of FIG. 3, the content streams of FIG. 4-6, and the flowcharts of FIG. 7-14.

Example data flows through various network nodes of the content distribution system are shown in FIG. 3. Referring to FIG. 3, the content source 100/110 provides (block 300) adaptive streaming friendly transcoder content streams (e.g., plurality of different coding bit rates of a same source media content). The streaming segmenter node 108 generates (block 302) a series of segmented files which are communicated using a single distribution container format. The segmented files are communicated to a content delivery network (CDN) server 116, which distributes (block 304) the files using the single distribution container format to an edge replication server 116. The edge replication server 116 further distributes (block 306) the files using the single distribution container format to an adaptive streaming re-segmenter node 128. The adaptive streaming re-segmenter node 128 combines the segmented files to generate (block 308) different format content streams, as need for communication according to different streaming protocols used by various UEs 140. The adaptive streaming re-segmenter node 128 provides adaptive bit rate streaming of the content the UEs 140 using selected ones of the format content streams which are compatible with the different streaming protocols used by corresponding ones of the UEs 140.

Accordingly, the responsibility for generating different format adaptive bit rate content streams is placed on the adaptive streaming re-segmenter node 128, which can be located close to the UEs. In some embodiments, the adaptive streaming re-segmenter node 128 may be a separate physical network node located in the communication pathway between the edge replication server 124 and the UEs 140. In some other embodiments, the adaptive streaming re-segmenter node 128 may be provide by functional modules that are part of the edge replication server 124 and/or that are part of the CDN server 116.

Further operations and methods that can be performed by the content distribution network, according to some further embodiments, are described below with regard to the block diagram of FIG. 2, the content streams of FIG. 4-6, and the flowcharts of FIG. 7-14

The adaptive streaming segmenter node 108 is configured to receive (block 700, FIG. 7), from the adaptive streaming friendly transcoders 104 and/or from the VOD server 110, a first plurality of content streams 106/112 having different coding bit rates of a same source media content. Each of the first plurality of content streams are segmented (block 702, FIG. 7) into a corresponding series of segmented files. The adaptive streaming segmenter node 108 communicates (block 704, FIG. 7) the series of segmented files for each of the first plurality of content streams using a single distribution container format (e.g., a single format selected responsive to one of: HLS protocol, HTTP Dynamic Streaming protocol, MPEG DASH protocol, Smooth Streaming protocol, or another protocol) for each of the series of segmented files. The series of segmented files are communicated using the single distribution container format toward the adaptive streaming re-segmenter node 128 through, for example, the CDN server 116, a content distribution network 120, and the edge replication server 124.

The segmentation, of each of the first plurality of content streams, can be performed by writing (block 800, FIG. 8) each successive segment of a first defined length to a different segmented file (e.g., a defined addressable range in memory which may include semiconductor memory, magnetic storage, etc.) to generate the corresponding series of segmented files for the content stream. The adaptive streaming segmenter node 108 can respond (block 900, FIG. 9) to completion of writing one of the segmented files by communicating the complete written one of the segmented files toward the adaptive streaming re-segmenter node.

Thus, when writing of an individual segmented file is completed, the individual segmented file can be communicated as one of the series of single format adaptive streaming segmented files 114 to the origin CDN server 116. The CDN server 116 can correspondingly output the single format adaptive streaming segmented files 114 through the content distribution network 120 to a closest edge replication server 124.

FIG. 4 illustrates a non-limiting example embodiment in which a series of segmented files 410, 420 are output by the adaptive streaming segmenter node 108 of FIGS. 1,2 according to some embodiments. Referring to FIG. 4, the adaptive streaming segmenter node 108 receives a plurality of content streams 106 or 112 having different coding bit rates from the adaptive streaming friendly transcoders 104 or the VOD server 110. Each of the example content streams 106 or 112 may include multiplexed video content and audio content, or the video content and audio content may be provided in separate adaptation sets (e.g., separate streams for video and audio). The adaptive streaming segmenter node 108 segments a first stream (stream 1), containing audio and video content encoded with a first bitrate to provide a corresponding series of segmented video files 410 and segmented audio files 420. Similarly, the adaptive streaming segmenter node 108 segments a second stream (stream 2) containing audio and video content encoded with a second bitrate to provide a corresponding series of segmented video files 410 and segmented audio files 420, and can repeat the segmentation process for “n” other streams encoded with “n” other bitrates to provide “n” other corresponding series of segmented video files 410 and segmented audio files 420. In the example, n is a plural natural number.

The adaptive streaming segmenter node 108 also outputs a manifest 430 representation containing informational descriptions of the series of segmented files 410,420, which may include, but are not limited to: 1) identifying files that comprise related media content; 2) identifying heuristic parameters of the segmented files 410,420, such as bit rate; and/or 3) identifying addressable locations of the files in memory (e.g., magnetic disk drive, semiconductor memory, etc.) for accessibility by a client module on the UEs 140. The manifest 430 is communicated from the adaptive streaming segmenter node 108 to the adaptive streaming re-segmenter node 128 via, for example, the origin CDN server 116, the content distribution network 120, and the edge replication server 124.

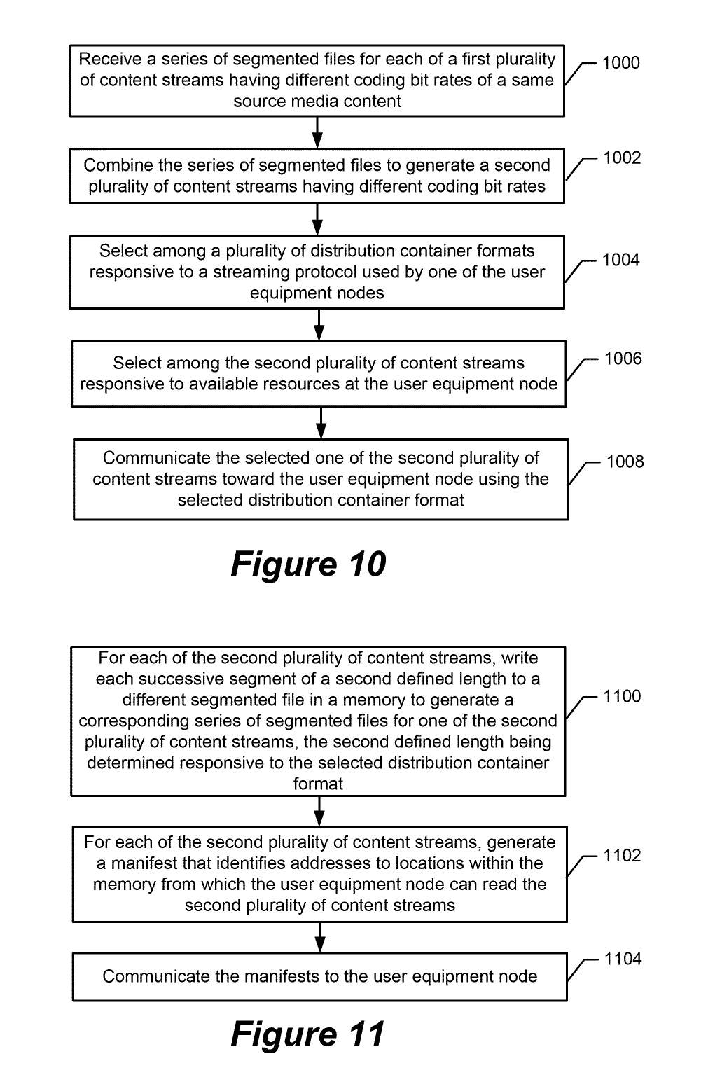

The adaptive streaming re-segmenter node 128 receives (block 1000, FIG. 10) the series of single format adaptive streaming segmented files 114 from the edge replication server 124. In some embodiments, the adaptive streaming re-segmenter node 128 reads (block 1400, FIG. 14) the series of segmented files 126, using the manifest 430, from the edge replication server 124 and/or from the CDN server 116. The series of segmented files are combined (block 1002, FIG. 10) to generate a second plurality of content streams having different coding bit rates. The second plurality of content streams may be identical to the first plurality of content streams that are provided to the adaptive streaming segmenter node 108. Thus, the adaptive streaming re-segmenter node 128 may regenerate the broadcast adaptive streaming friendly transmitted streams 106 or the VOD adaptive streaming friendly transmitted streams 112 that are provided to the adaptive streaming segmenter node 108.

The adaptive streaming re-segmenter node 128 selects (block 1004) among a plurality of distribution container formats responsive to a streaming protocol that is used by one of the UEs 140 which will receive the content stream. Thus, for example, when the content stream is being provided to the tablet computer 142, the adaptive streaming re-segmenter node 128 can select a first distribution container format that is compatible with the Apple initiated HLS streaming protocol. Similarly, the adaptive streaming re-segmenter node 128 can select the following distribution container formats for use in streaming the content stream to the other UEs 140, for example, as follows: for the television 144, select a second distribution container format compatible with Microsoft initiated Smooth Streaming over HTTP protocol; for the game console 146, select a third distribution container format compatible with the Adobe initiated Dynamic Streaming protocol; for the personal computer 148, select a fourth distribution container format compatible with MPEG DASH protocol.

Other distribution container formats may be used as desired/needed for other streaming protocols that may be use by UEs, and a single UE may have a plurality of different client modules that use a plurality of different streaming protocols. Accordingly, a plurality of different distribution container formats may be simultaneously used in a plurality of streaming sessions between the adaptive streaming re-segmenter node 128 and client modules on a single UE to communicate streaming content.

The selected distribution container format may make it desirable/required to re-segment the second plurality of content streams to have a different segment size than used by the adaptive streaming segmenter node 108 to segment the first plurality of content streams 106/112. Because the adaptive streaming segmenter node 108 can output a plurality of different formats as needed by the UEs 140, the adaptive streaming segmenter node 108 can re-segment the second plurality of content streams to provide a different size for the segmented files, when needed, for each different format.

The bit rate of the content stream that is provided to one of the UEs 140 can be dynamically adjusted, to provide adaptive bitrate content streaming, by selecting (block 1006, FIG. 10) among the second plurality of content streams, which have different coding bit rates, in response to the present bandwidth and/or CPU capacity of the UE. The UE may control the selection (e.g., by communicating selection requests, such as read requests, for a particular one of the content streams) and/or the adaptive streaming re-segmenter node 128 may control the selection (e.g., by determining the bandwidth and/or capacity of the UE, such as by determining a present input buffer capacity of the UE).

The selected one of the second plurality of content streams is communicated (Block 1008, FIG. 10) toward the user equipment node using the selected distribution container format.

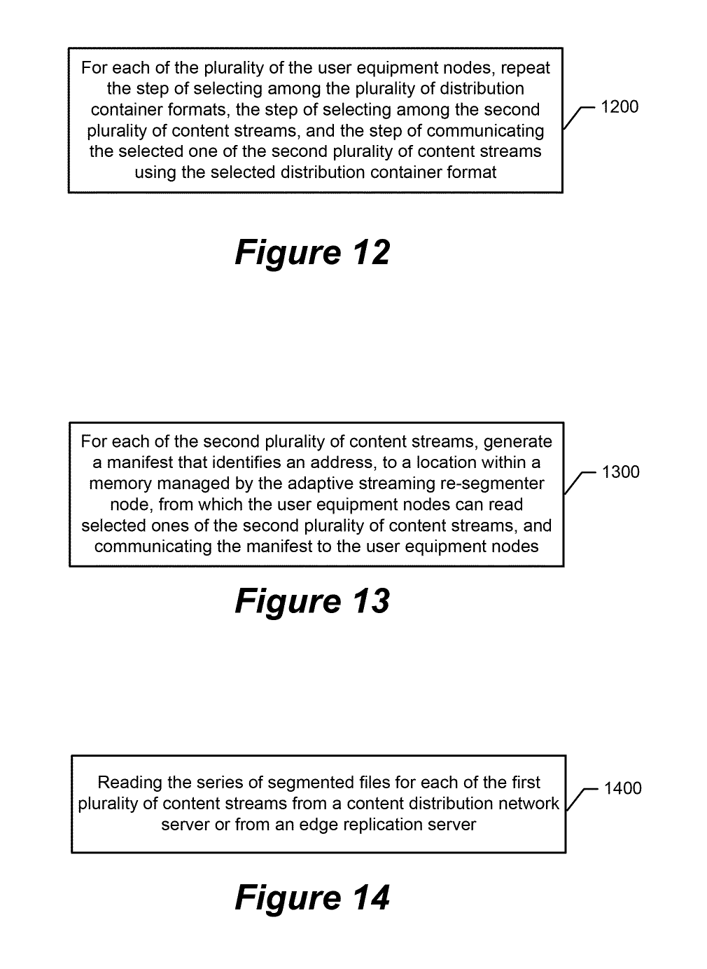

The operations and methods of FIG. 10 can be repeated (block 1200 of FIG. 12) for each of the UEs 140 so that the adaptive streaming re-segmenter node 128 functions to communicate adaptive streaming of content to each of the UEs 140 using distribution container formats that are selected for compatibility with each streaming protocol used by the UEs 140.

To re-segment and communicate the second plurality of content streams, the adaptive streaming re-segmenter node 128 can, for each different format of the second plurality of content streams, generate a manifest (block 1300, FIG. 13) that identifies an address, to a location within a memory managed by the adaptive streaming re-segmenter node 128, from which the UEs 140 can read selected ones of the second plurality of content streams to control the content streaming bitrate to the corresponding UEs 140. A different manifest can be generated for each different distribution container format that can be output by the adaptive streaming re-segmenter node 128.

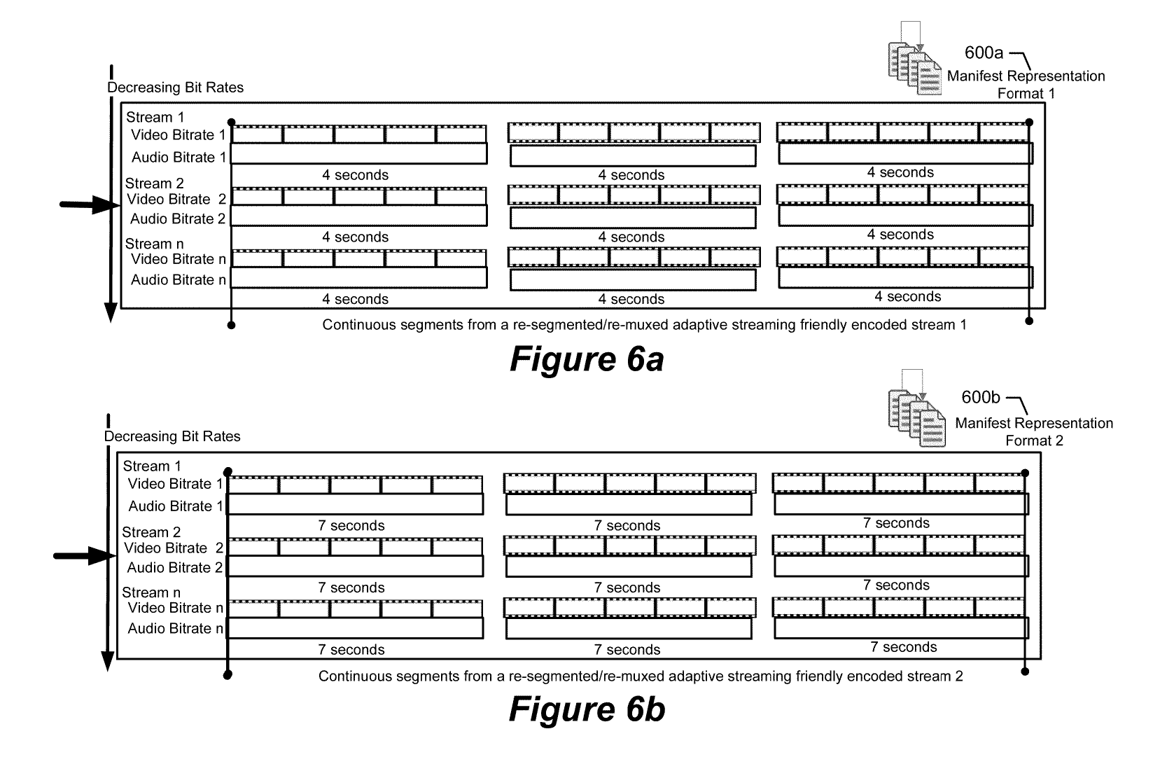

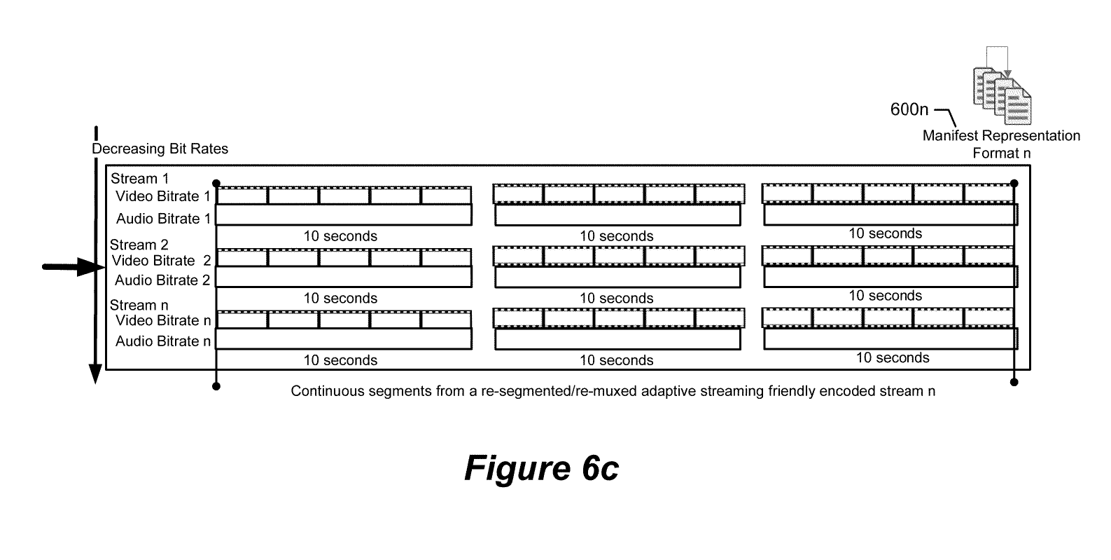

By way of further example, FIGS. 5 and 6a-b illustrates a plurality of different format content streams that are generated by the adaptive streaming re-segmenter node 128 by combining the segmented content streams of FIG. 4 according to some embodiments. Referring to FIG. 5, the adaptive streaming re-segmenter node 128 reads the manifest 430, and combines the series of segmented files to generate n different segmented second plurality of content streams (e.g., stream 1 having video bit rate 1 and audio bit rate 1; stream 2 having video bit rate 2 and audio bit rate 2; and so on to stream “n” having video bit rate “n” and audio bit rate “n”).

The adaptive streaming re-segmenter node 128 further generates “n” different distribution container formats of the second plurality of content streams (e.g., “re-segment/remux stream 1”, “re-segment/remux stream 2”, “re-segment/remux stream n” of FIG. 5) as needed to stream the content according to the “n” different protocols required by the UEs 140. For example, the second plurality of content streams can be re-segmented using different segment lengths that are determined based on each of the selected formats. Moreover, the video content and audio content may be multiplexed together or separated into separate video and audio streams as desired/required for various streaming protocols used by different ones of the UEs 140 when generating the “n” different formatted content streams “re-segment/remux stream 1”, “re-segment/remux stream 2”, “re-segment/remux stream n” of FIG. 5). Examples of “n” different formatted content streams are shown in FIGS. 6a-c.

Referring to FIG. 6a, first formatted re-segmented/remuxed group of streams are generated as a series of segmented files of length 4 seconds for each of the bit rate streams. The adaptive streaming re-segmenter node 128 generates a corresponding manifest 600a that identifies addresses to locations within a memory from which the UEs 140 can read the series of files for a selected bit rate having the first format. The manifest 600a may contain other information as explained above, such as information that identifies files that comprise related media content, information identifying bit rate or other heuristic parameters of the files, etc.

The first formatted content streams can be generated, from each of the second plurality of content streams (e.g., the different rate content streams of FIG. 5), by writing (block 1100, FIG. 11) each successive segment of a defined length (e.g., 4 seconds) to a different segmented file in the memory to generate a corresponding series of segmented files. A manifest can be generated (block 1102, FIG. 11) for the first format content streams that identifies addresses to locations within the memory from which the UEs 140 can read the first format content streams. The manifest is communicated (block 1104, FIG. 11) to the UEs 140 which have compatible streaming protocols.

Referring to FIG. 6b, by similar operations to those of FIG. 6a, second formatted re-segmented/remuxed group of streams are generated as a series of segmented files of length 7 seconds for each of the bit rate streams. The adaptive streaming re-segmenter node 128 generates a corresponding manifest 600b that identifies addresses to locations within a memory from which the UEs 140 can read the series of files for a selected bit rate having the second format. The manifest 600b may contain other information as explained above. The manifest 600b is communicated to the UEs 140 which have compatible streaming protocols.

Referring to FIG. 6c, similarly, “nth” formatted re-segmented/remuxed group of streams are generated as a series of segmented files of length 10 seconds for each of the bit rate streams. The adaptive streaming re-segmenter node 128 generates a corresponding manifest 600n that identifies addresses to locations within a memory from which the UEs 140 can read the series of files for a selected bit rate having the “nth” format. The manifest 600n may contain other information as explained above. The manifest 600n is communicated to the UEs 140 which have compatible streaming protocols.

Example Network Node:

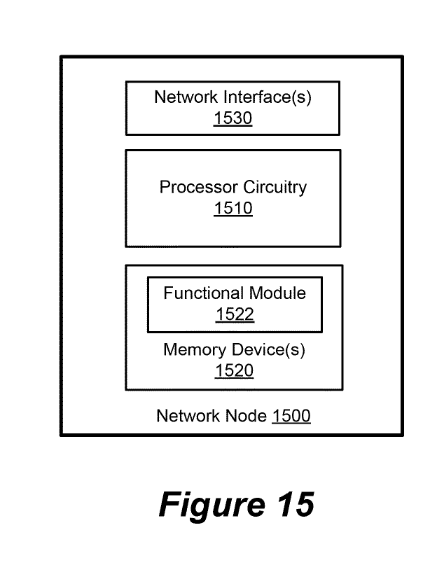

FIG. 15 is a block diagram of a network node 1500 that is configured according to some embodiments. The network node 1500 may be used in one or more of the network nodes described above with regard to FIGS. 1-14, including, but not limited to, the content source 100/110, the adaptive streaming friendly transcoders 104, the adaptive streaming segmenter node 108, the CDN server 116, one or more nodes of the content distribution network 120, the edge replication server 124, the adaptive streaming re-segmenter node 128, and/or one or more of the UEs 140. The network node 1500 can include one or more network interfaces 1530, processor circuitry 1510, and memory circuitry/devices 1520 that contain functional modules 1522. The network node 1500 may further include radio transceiver circuitry when included in a wireless communication type of UE 140 (e.g., mobile phone, wireless computer, etc.).

The processor circuitry 1510 may include one or more data processing circuits, such as a general purpose and/or special purpose processor (e.g., microprocessor and/or digital signal processor). The processor circuitry 1510 is configured to execute computer program instructions from the functional modules 1522 in the memory circuitry/devices 1520, described below as a computer readable medium, to perform some or all of the operations and methods that are described above for one or more of the embodiments, such as the embodiments of FIGS. 1-14.

### FURTHER DEFINITIONS AND EMBODIMENTS

In the above-description of various embodiments of the present invention, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” or “/” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

1. A method by a content distribution system for providing adaptive rate content streams to a plurality of user equipment nodes, the method comprising the steps of:
receiving a first plurality of content streams having different coding bit rates of a same source media content;
segmenting each of the first plurality of content streams into a corresponding series of segmented files;
communicating the series of segmented files for each of the first plurality of content streams from an adaptive streaming segmenter node toward an adaptive streaming re-segmenter node through a content distribution network using a single distribution container format for each of the series of segmented files;
combining, at the adaptive streaming re-segmenter node, each of the series of segmented files to generate a second plurality of content streams having different coding bit rates;
selecting among a plurality of distribution container formats responsive to a streaming protocol used by one of the user equipment nodes;
selecting among the second plurality of content streams responsive to available resources at the user equipment node; and
communicating the selected one of the second plurality of content streams from the adaptive streaming re-segmenter node toward the user equipment node using the selected distribution container format.

2. The method of claim 1, wherein the second plurality of content streams are identical to the first plurality of content streams.

3. The method of claim 1, wherein segmenting each of the first plurality of content streams into the corresponding series of segmented files comprises:
for each of the first plurality of content streams, writing each successive segment of a first defined length to a different segmented file to generate the corresponding series of segmented files for one of the first plurality of content streams.

4. The method of claim 3, further comprising the step of:
responding to completion of writing one of the segmented files by initiating the step of communicating the complete written one of the segmented files from the adaptive streaming segmenter node toward the adaptive streaming re-segmenter node.

5. The method of claim 3, wherein communicating the selected one of the second plurality of content streams from the adaptive streaming re-segmenter node toward the user equipment node using the selected distribution container format, comprises:
writing each successive segment of the selected one of the second plurality of content streams of a second defined length to a different segmented file, the second defined length being determined responsive to the selected distribution container format.

6. The method of claim 1, further comprising the steps of, by the adaptive streaming re-segmenter node:
for each of the plurality of the user equipment nodes, repeating the step of selecting among the plurality of distribution container formats, the step of selecting among the second plurality of content streams, and the step of communicating the selected one of the second plurality of content streams using the selected distribution container format,
wherein at least two of the user equipment nodes use different streaming protocols for which the adaptive streaming re-segmenter node selects different distribution container formats.

7. The method of claim 6, further comprising:
for each of the second plurality of content streams, generating a manifest that identifies an address, to a location within a memory managed by the adaptive streaming re-segmenter node, from which the user equipment nodes can read selected ones of the second plurality of content streams, and communicating the manifest to the user equipment nodes.

8. The method of claim 7, wherein communicating the selected one of the second plurality of content streams from the adaptive streaming re-segmenter node toward the user equipment node using the selected distribution container format comprises:
responding to a read request identifying an address in the memory of a segment of the one of the second plurality of content streams, by communicating the segment from the adaptive streaming re-segmenter node toward the user equipment node using the selected distribution container.

9. The method of claim 6, wherein selecting among the plurality of distribution container formats responsive to the streaming protocol used by the user equipment node comprises:
selecting among a HTTP Live Streaming protocol, a HTTP Dynamic Streaming protocol, a MPEG Dynamic Adaptive Streaming over HTTP protocol, and a Smooth Streaming protocol.

10. The method of claim 1, further comprising the steps of, by the adaptive streaming re-segmenter node:
reading the series of segmented files for each of the first plurality of content streams from a content distribution network server or from an edge replication server.

11. An adaptive streaming segmenter node of a content distribution system for providing adaptive rate content streams for a plurality of user equipment nodes, the adaptive streaming segmenter node comprising:
at least one network interface configured to receive a first plurality of content streams having different coding bit rates of a same source media content; and
circuitry configured to:
segment each of the first plurality of content streams into a corresponding series of segmented files; and
communicate the series of segmented files for each of the first plurality of content streams toward an adaptive streaming re-segmenter node through the at least one network interface and a content distribution network using a single distribution container format for each of the series of segmented files.

12. The adaptive streaming segmenter node of claim 11, wherein the circuitry is further configured to:
segment each of the content streams into the corresponding series of segmented files by, for each of the first plurality of content streams, writing each successive segment of a first defined length to a different segmented file to generate the corresponding series of segmented files for the content stream.

13. The adaptive streaming segmenter node of claim 12, wherein the circuitry is further configured to:
respond to completion of writing one of the segmented files by communicating the complete written one of the segmented files toward the adaptive streaming re-segmenter node.

14. An adaptive streaming re-segmenter node of a content distribution system for providing adaptive rate content streams to a plurality of user equipment nodes, the adaptive streaming re-segmenter node comprising:
at least one network interface configured to receive a series of segmented files for each of a first plurality of content streams having different coding bit rates of a same source media content; and
circuitry configured to:
combine the series of segmented files to generate a second plurality of content streams having different coding bit rates;
select among a plurality of distribution container formats responsive to a streaming protocol used by one of the user equipment nodes;
select among the second plurality of content streams responsive to available resources at the user equipment node; and
communicate the selected one of the second plurality of content streams toward the user equipment node using the selected distribution container format.

15. The adaptive streaming re-segmenter node of claim 14, wherein the circuitry is further configured to:
combine the series of segmented files to generate the second plurality of content streams to be identical to the first plurality of content streams.

16. The adaptive streaming re-segmenter node of claim 14, wherein the circuitry is further configured to communicate the selected one of the second plurality of content streams toward the user equipment node using the selected distribution container format by:
for each of the second plurality of content streams, writing each successive segment of a defined length to a different segmented file in a memory to generate a corresponding series of segmented files for one of the second plurality of content streams;
for each of the second plurality of content streams, generating a manifest that identifies addresses to locations within the memory from which the user equipment node can read the second plurality of content streams; and
communicating the manifests to the user equipment node.

17. The adaptive streaming re-segmenter node of claim 14, wherein the circuitry is further configured to:
for each of the plurality of the user equipment nodes, repeat the selection among the plurality of distribution container formats, the selection among the second plurality of content streams, and the communication of the selected one of the second plurality of content streams using the selected distribution container format,
wherein at least two of the user equipment nodes use different streaming protocols for which the circuitry of the adaptive streaming re-segmenter node selects different distribution container formats.

18. The adaptive streaming re-segmenter node of claim 17, wherein the circuitry is further configured to:
for each of the second plurality of content streams, generate a manifest that identifies an address, to a location within a memory managed by the adaptive streaming re-segmenter node, from which the user equipment nodes can read selected ones of the second plurality of content streams; and
communicate the manifest to the user equipment nodes.

19. The adaptive streaming re-segmenter node of claim 14, wherein the circuitry is further configured to select among the plurality of distribution container formats responsive to the streaming protocol used by the user equipment node by:
selecting among a HTTP Live Streaming protocol, a HTTP Dynamic Streaming protocol, a MPEG Dynamic Adaptive Streaming over HTTP protocol, and a Smooth Streaming protocol.

20. The adaptive streaming re-segmenter node of claim 14, wherein the circuitry is further configured to:
read the series of segmented files for each of the first plurality of content streams from a content distribution network server or from an edge replication server.
